(19) United States
(12) Patent Application Publication
(10) Pub. No.: US 2025/0178840 A1
(43) Pub. Date: Jun. 5, 2025

(54) SYSTEM AND/OR AIRBORNE DEVICE FOR STORAGE AND/OR TRANSPORTATION WITH LONG DURATION AND/OR HIGH LOAD CAPACITY AND/OR HIGH STRENGTH AND/OR HIGH FLEXIBILITY AND/OR HIGH MODULARITY

(71) Applicant: Jose Eduardo ARIAS SANCHEZ, Mexico City (MX)

(72) Inventor: Jose Eduardo ARIAS SANCHEZ, Mexico City (MX)

(21) Appl. No.: 19/045,477

(22) Filed: Feb. 4, 2025

(30) Foreign Application Priority Data
Dec. 4, 2023 (MX) MX/U/2023/000506

(51) Int. Cl. B65G 9/00

(52) U.S. Cl. CPC B65G 9/002; B65G 9/006; B65G 9/008; B65G 2205/06

(57) ABSTRACT

Devices and systems for aerial accumulation and transportation with high durability, high load capacity, high resistance, high flexibility and high modularity for applications in industries requiring the transportation and accumulation of parts, objects, products, materials, and others via an aerial rail are disclosed and described.

### CROSS-REFERENCE TO RELATED APPLICATIONS

This application claims priority to Mexican Patent Application No. MX/u/2023/000506, filed Dec. 4, 2023. The entire contents of the above-listed application are hereby incorporated by reference for all purposes.

### BACKGROUND OF THE INVENTION

The present invention relates to an airborne system and/or device for storage and/or transportation with long duration and/or high load capacity and/or high strength and/or high flexibility and/or high modularity, for use in industries requiring transportation and/or storage of parts, objects, products, and materials, among others, via an aerial rail and/or for material handling tasks that aim to avoid the use of forklifts, carts, containers, and/or other methods of load or part movement in contact with the floor. This is because the present invention enables efficient airborne movement of parts, either manually and/or using gravity and/or external motorization support.

Currently, there are other monorail transportation/storage systems and/or devices and these systems are characterized by accumulating, running, and maintaining motion over a single rail. They are typically used for lightweight parts without reinforcements. When these systems and/or devices are subjected to higher loads or to greater effort, they are damaged or deformed, or simply cannot be used because their components are not strong enough to withstand greater loads or efforts. This presents significant issues and problems for the end user, which represents an additional cost. Therefore, there is a need for systems and/or devices that are resistant enough to improve, expand, and/or perfect their functionality within their operational range, addressing all these problems and issues for the end user.

The present invention improves existing systems and/or devices. On one hand, its configuration allows for agility, while on the other, it makes the system stronger and more resistant, which not only extends its durability but also its range of applications. This allows it to be a highly practical and resistant system and/or device supporting all types of industries to enable storage and/or mobility of products inside and outside production plants, helping the industry to keep parts organized, visible, maintaining their manufacturing order, and allowing them to be transported efficiently to workstations, supporting various production methods such as such as “FIFO” (First In, First Out) and “JIS” (Just-In-Sequence), amongst others required by the industry.

The configuration of the systems and/or devices in the present invention solves all the issues and problems of current systems and/or devices, particularly those found in the patents MX 341360 B, MX 342094 B, and MX 362734 B, both as a whole and in the individual components that make up their functionality.

Here, some important improvements over previous inventions are briefly described:

Regarding patent MX 341360 B, The “U”-shaped structure (201) of the rolling unit (200) shown in FIGS. 3 and 4 tends to open, compromising functionality and operator safety as the rolling unit may detach from the rail.

Regarding patent MX 342094 B Element 200 (the “U”-shaped rolling unit structure) in FIGS. 1, 2, and 3 also tends to open, risking cart detachment and posing a safety hazard for operators and materials. Shown in FIG. 3, the support element 501 (mechanical stop mechanism) and 507 (mechanical stop mechanism activator) are prone to displacement, leading to poor coupling and loss of functionality, exit of the carts from the rail, and they do not have elements that help either to dose pieces or to maintain coupling. In FIG. 3 the element 402 (straight upper guide tip) by being totally straight fails to ensure proper coupling or maintain position with the element 401 (centering cone). In contrast, the present invention solves this problem.

Regarding patent MX 362734 B, In the “Rosary Part Carrier” cart (FIGS. 3 and 10), components like element 18 (retention tabs) and 5 (metallic articulation parts) shown in FIGS. 4, 6, and 9 weaken the structure, especially in scenarios like FIG. 8. In contrast, the present system does not require these components. On the other hand, the element 7 (side pin) is riveted to element 11 (metal tube) in FIGS. 3 and 10, making replacement difficult if bent over time after stopping engaging shocks whilst the present system goes screwed on a rivet increasing resistance. The element 6 (rocker linkage) clearly shown in FIG. 7 experiences high stress from cart impacts, causing frequent breakage. The present system includes a metal core for added strength. The element 23 (pin) holds the entire load via integration with the element 24 (bushing) shown in FIG. 4, which significantly weakens its attachment to element 21 (supporting vertical shaft). The present system uses a threaded nut to the load-bearing screw, a clip for nut retention, and a protective cap for enhanced durability. Similarly, in FIG. 11, element 8 (stop station and unlinkage) tends to move backward after constant stopping engaging shocks. At the same point, element 88 (fixed stop) tends to cause decoupling and also moves backward with the impacts, eventually leading to poor coupling, while the present system is supported by at least 3 points of attachment. Element 84 (linkage stop) does not always work with all carts, whereas the present system offers an alternative integrated with a double rocker that provides more functionality.

By contrast to these prior solutions, the present system includes an improved upper support called “Mobile Clamp,” which secures the rail, allows lateral movement along a load beam, and ensures operator safety through its innovative design. Furthermore, the present invention employs at least 2 support channels on 3 sides, providing a higher level of reinforcement, capacity, and safety to the system and also allowing the attachment of the functional elements to the

“Flow Rail” using standard screws without the need for any other type of adapters for the rail's screws. Additionally, the present invention includes more functionalities to the the “Sliding Wheel Cart,” now called “Buggy,” combining lightweight materials with high resistance in a modern design, solving all the issues and problems of currently known systems and/or devices.

The previously mentioned documents do not affect the novelty of the present invention, as they neither mention nor suggest the parts that comprise it or their function. Therefore, the present utility model is new.

The system and/or device of the present invention increases load capacity, resolves operational problems, extends the lifespan of equipment, maintains easy operation, drastically improves safety for operators, and enhances profitability for companies.

### SUMMARY

The present invention relates to a system and/or device for aerial accumulation and/or transportation with high durability and/or high load capacity and/or high resistance and/or high flexibility and/or high modularity for applications in industries requiring the transportation and/or accumulation of parts, objects, products, materials, and others via an aerial rail. It also applies to material movements that seek to avoid the use of forklifts, carts, containers, and/or other methods that involve contact with the floor. This invention enables efficient movement of parts in the air (e.g. in a suspended or overhead manner), manually and/or with the use of gravity and/or external motorized assistance.

The system and/or device comprises various designs, integration, and mechanical elements that enhance functionality, including: A flow rail (2.a) with two fixing channels (2.b) on three of its sides, improving both the fixing of functional elements and the attachment of the flow rail (2.a) to a structural element where the mobile clamp (14.a) may be applied. On this flow rail (2.a), at least one Buggy (11.a, 12.a) moves and/or is stored, featuring a novel trolley (3.a), which interacts with functional elements such as the gate (19.a), creating a novel interaction with the releaser (19.b) when the receiver cone (19.c) and connector (18.a) join.

### BRIEF DESCRIPTION OF THE FIGURES

Below, through the following illustrations but without limitation, the main elements that make up the system and/or device of the present invention are described:

FIG. 1 is an isometric view showing several elements that are part of the system and/or device of the present invention, where two improved flow rails (2.a) are seen, positioned opposite each other and disconnected. Along one of them, the buggies (11.a, 12.a) run. At the end of the same flow rail (2.a), the elements that provide functionality are visible: the gate (19.a), receiver cone (19.c), connector (18.a), and a releaser (19.b). Above the other flow rail (2.a), a mobile clamp (14.a) is shown.

FIG. 2 is a front view of the improved Flow Rail (2.a), showing: the flow rail (2.a), the fixing channel (2.b), and the rolling tube (2.c).

FIG. 3 is an isometric view of the Trolley (3.a) and a view of the 5th Wheel System (3.b), showing: Trolley (3.a), 5th wheel system and/or device (3.b).

FIG. 4 is an isometric view of the elements that make up the Trolley (3.a), showing: the housing (4.a), clamping plate (4.b), rollers (4.c), load pin (4.d), spring (4.e), friction washer (4.f), nut (4.g), cap (4.h), clip (4.i), support (4.j), 5th wheel (4.k), 5th wheel pin (4.l), 5th wheel nut (4.m), 5th wheel clamp plate (4.n), pressure washers (4.o), front clamping bolts (4.p), spring support (4.q), thread (4.r), fixing ring (4.s), 5th wheel system supports (4.t).

FIG. 5 is an isometric view of the elements that make up the ends of the buggies (11.a and 12.a), showing: link (5.a), link protector (5.b), support (5.c), pin (5.d), pin washer (5.e), pin pressure washer (5.f), shock absorber (5.g).

FIG. 6 is a transparency of the link (5.a) showing the integration of the internal reinforcement element, showing: link core (6.a), and link cover (6.b).

FIG. 7 is an isometric view of the support (5.c) where rivets at both ends are visible, showing: rivet (7.a), load drillings (7.b).

FIG. 8 is an isometric bottom view showing the sling (8.a) applied to buggies (11.a) with 2 or more supports, showing: the sling (8.a).

FIG. 9 is an isometric view of the lower section of the sling (8.a) showing the integration of its elements, showing: assembly plate (9.a), and spacer (9.b).

FIG. 10 is an isometric view showing the sections of the sling (8.a), showing: the upper sling section (10.a), and the bottom sling section (10.b).

FIG. 11 is an isometric view of a buggy with more than 2 supports, showing: the 3-support buggy (11.a).

FIG. 12 is a side view of a buggy with more than 1 support, showing: the buggy (12.a).

FIG. 13 is a top view showing the linkage (13.a) between two links (5.a), showing: the linkage (13.a).

FIG. 14 is an isometric top view of the mobile clamp (14.a), showing: the mobile clamp (14.a), upper rail fastening screws (14.b), lateral rail fastening screws (14.c).

FIG. 15 is an isometric view of the elements that make up the mobile clamp (14.a), showing: bearing beam fastening plate (15.a), beam support (15.b), clamp assembly plate (15.c), bearing support assembly set (15.d), bearing twist assembly set (15.e), lateral rail fastening plate (15.f), permanent positioning screw (15.g), and a height adjustment plate (15.h).

FIG. 16 is an isometric bottom view of the mobile clamp (14.a), showing: complete fastening screws (16.a).

FIG. 17 is an isometric view of the mobile clamp (14.a) in use, holding the flow rail (2.a) through a load beam (17.a), showing: the load beam (17.a).

FIG. 18 is a side view of the flow rail (2.a), disconnected between the connector (18.a) and receiver cone (19.c), showing: the connector (18.a).

FIG. 19 is an isometric view of the elements of the flow rail (2.a), including the gate (19.a), receiver cone (19.c), connector (18.a), releaser (19.b), and a mobile clamp (14.a), showing: the gate (19.a), releaser (19.b), receiver cone (19.c).

FIG. 20 is a view of the elements that make up the gate (19.a), showing: gate support (20.a), doser (20.b), lock (20.c), doser limiting screw (20.d), spacer for doser limiting screw (20.e).

FIG. 21 is an isometric view of the elements of the doser (20.b), showing: advance limiter (21.a), activation rocker (21.b), front fastening assembly for doser (21.c), rear fastening assembly for doser (21.d), counterweight (21.e).

FIG. 22 is an isometric view of the elements of the lock (20.c), showing: lock main support (22.a), anti-return (22.b), lock main support complement (22.c), bolt elevation assembly for lock (22.d), front fastening assembly for lock (22.e), rear fastening assembly for lock (22.f), lock union reinforcement screw (22.g).

FIG. 23 is an isometric view of the releaser (19.b), showing: the holder (23.a).

FIG. 24 is a view of the elements of the releaser (19.b), showing: releaser support (24.a), holder plate (24.b), holder fastening screw (24.c), holder spacer (24.d).

FIG. 25 is an isometric view of the receiver cone (19.c), showing: receiver cone fastening screw (25.a).

FIG. 26 is an isometric view of the connector (18.a), showing: connection bolt (26.a), centering cone (26.b), connector support (26.c), lower travel bolt (26.d), front rail fastening screw (26.e), centering cone fastening screw (26.f).

FIG. 27 is a lateral view of the flow rail (2.a) in connection between the connector (18.a) and the receiver cone (19.c), showing the lock (20.c) interacting with the releaser (19.b) and the holder (23.a). On the left side, the arrival of a buggy (12.a) is visible, showing: the locking point (27.a).

FIG. 28 is a lateral view of the flow rail (2.a) in connection, showing the passage of a buggy (12.a) from the left side, where the connector (18.a) is located, to the right side, where the receiver cone (19.c) is located, having already passed through the doser (20.b).

FIG. 29 is a lateral view of the flow rail (2.a) in connection, showing the passage of two buggies (12.a) from the left side, where the connector (18.a) is located, to the right side, where the receiver cone (19.c) is located, interacting with the activation rocker (21.b).

FIG. 30 is a lateral view of the flow rail (2.a) in connection, showing the passage of two buggies (12.a) from the left side, where the connector (18.a) is located, to the right side, where the receiver cone (19.c) is located, and generating the action with the advance limiter (21.a) after the activation rocker (21.b) has been moved.

FIG. 31 is a lateral view of the flow rail (2.a) in connection, showing the passage of two buggies (12.a) from the left side, where the connector (18.a) is located, to the right side, where the receiver cone (19.c) is located, and generating the breaking of the linkage (13.a) between the two buggies (12.a) through the action of the advance limiter (21.a) and the activation rocker (21.b).

### DESCRIPTION OF THE INVENTION

The present invention refers to an aerial system and/or device for accumulation and/or transportation of high duration and/or high load capacity and/or high resistance and/or high flexibility and/or high modularity, intended for general industry applications that require the transportation and/or accumulation of pieces, objects, products, materials, and others, through an aerial rail and/or for material movements where the use of forklifts, carts, containers, and/or other floor-contact methods of piece transport or movement is to be avoided. This invention allows for the efficient movement of pieces in the air, manually and/or using gravity and/or with external motorization support.

The system and/or device includes various mechanical elements and design configurations that enhance and improve the functionalities of the system and/or device of the present invention.

It mainly consists of a flow rail (2.a), shown in FIG. 2, which features two fixing channels (2.b) on the sides and at the top. These channels are essential for fixing functional elements such as the gate (19.a), the receiver cone (19.c), the connector (18.a), the releaser (19.b), and a mobile clamp (14.a), as seen in FIG. 19. The fixing channel size (2.b) allows the use of standard hexagonal-headed screws, a significant departure from current systems, which only have a lateral and an upper guide, limiting their functionality and capacities.

In the system and/or device of the present invention, the wheel cart or buggies (11.a and 12.a), as we have named them, are the integral elements that enable the movement or storage of products within and outside production plants and warehouses.

In the rolling tube (2.c) of the flow rail (2.a), the buggies (11.a and 12.a) travel, characterized by having at least one trolley (3.a) consisting of several elements, as shown in FIG. 4, such as the housing (4.a), the main body element with several angles, cavities, and protrusions, including a spring support (4.q) and guides, which are the 5th-wheel system supports (4.t). It also has a clamping plate (4.b), which is a plate with internal cuts to secure the rollers (4.c), a load pin (4.d), which is a rounded tubular shape with threading (4.r) and a fixing ring (4.s) to secure the load to the rail, a spring (4.e) that returns the link (5.a) to its position each time it interacts with the activation rocker (21.b) of the doser (20.b), a friction washer (4.f) to reduce wear, a nut (4.g) to secure the load, a cap (4.h) to prevent scratches on loaded items, and a clip (4.i) that holds both the cap (4.h) and the nut (4.g) in place.

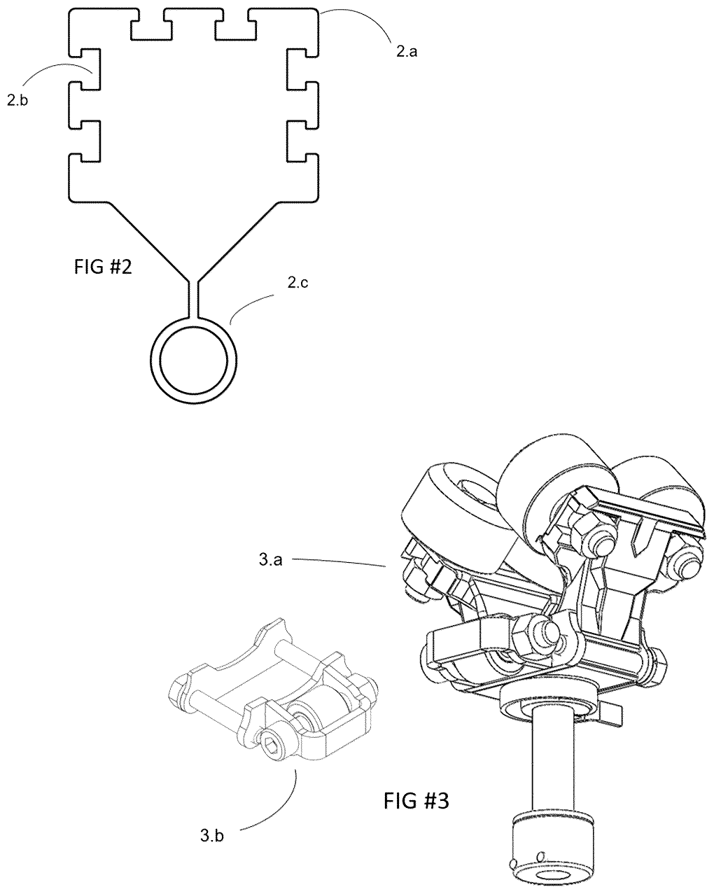

The trolley (3.a) now has the option to include a 5th-wheel system (3.b), shown in FIG. 3, which includes a support (4.j) that holds the 5th wheel (4.k) through a 5th-wheel pin (4.l) secured with a 5th-wheel nut (4.m). Everything is connected by the 5th-wheel clamp plate (4.n), which is secured with front clamping bolts (4.p) and pressure washers (4.o) to hold them in place. Having the option to use this system now provides buggies (11.a and 12.a) with a new functional aid to prevent the trolley (3.a) from rubbing, thus avoiding friction when it experiences front twisting on an incline when using gravity, motorization, or when this is generated by the operator's interaction.

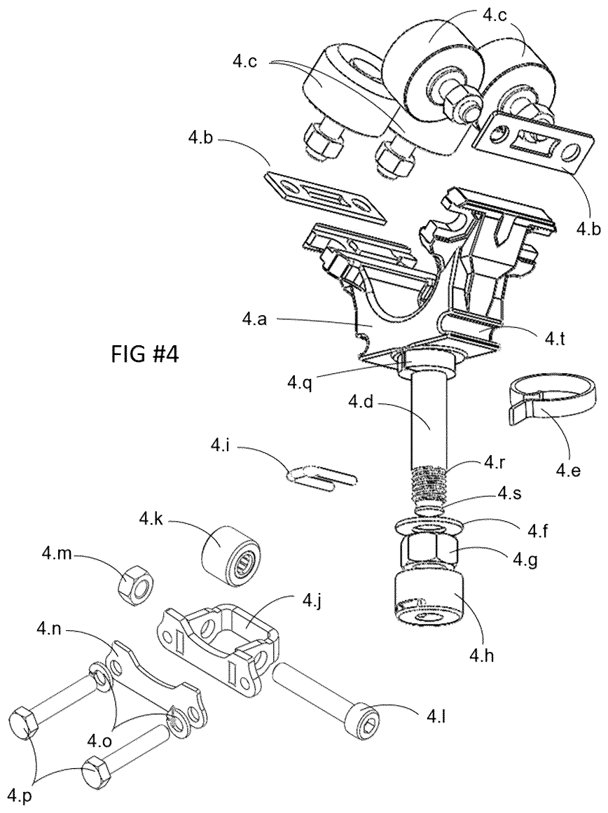

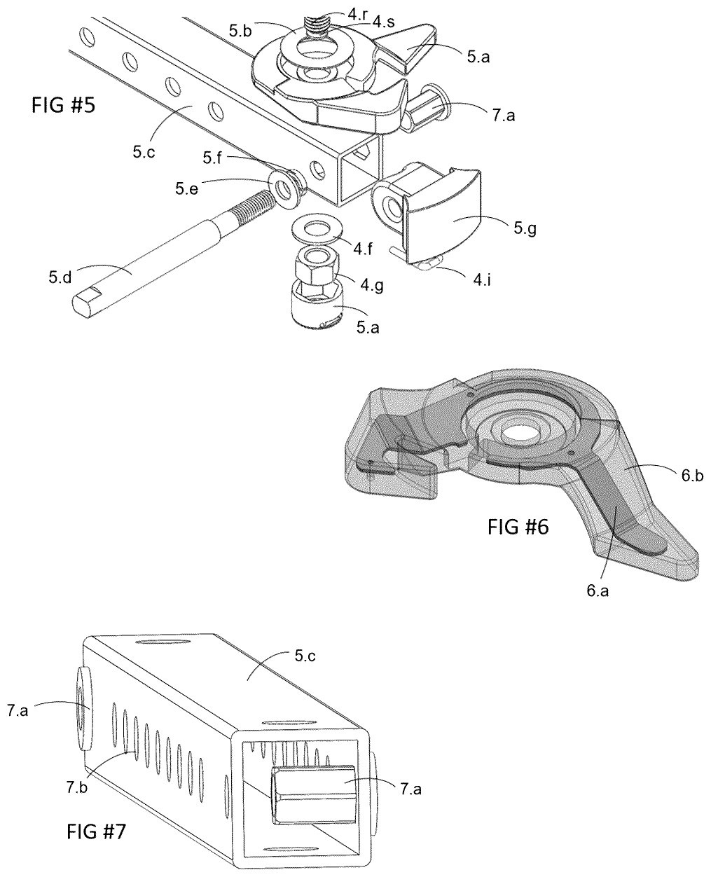

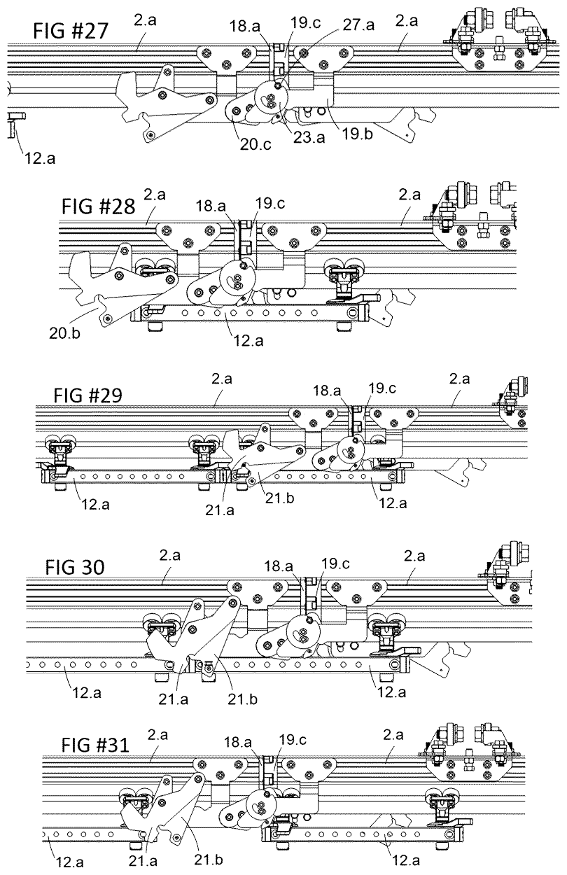

For this movement and accumulation process, at least one buggy (11.a and 12.a) is selected based on the size and/or weight of the object, product, or material, with the intention that it remains preferably within the shock absorbers (5.g) zone to protect it during movement and/or accumulation. The ends of the buggies (11.a and 12.a), as shown in FIG. 5, have several functional elements, such as the link (5.a), which allows the connection with another buggy (11.a and 12.a) through a linkage (13.a), as seen in FIG. 13, using a link protector (5.b) to avoid damage from friction, a support (5.c) where the load is added by securing it to the load drillings (7.b), a pin (5.d) that, with the help of a pin washer (5.e) and a pin pressure washer (5.f), is secured to the support (5.c) through a rivet (7.a), shown in FIG. 7. This rivet provides much greater resistance and allows for the possibility of exchanging the pin (5.d) after stoping engaging shocks with the lock (20.c), preventing the buggy (11.a and 12.a) from being limited. This is important because the pin (5.d) will also interact with the advance limiter (21.a), as shown in FIG. 30, and ultimately break the linkage (13.a), as shown in FIG. 31, through the cadence of left-to-right movement when viewed from that perspective.

It is important to mention that the link (5.a), as shown in FIG. 6, now has a key differentiator, the link core (6.a), which increases the piece's resistance when inside the link cover (6.b).

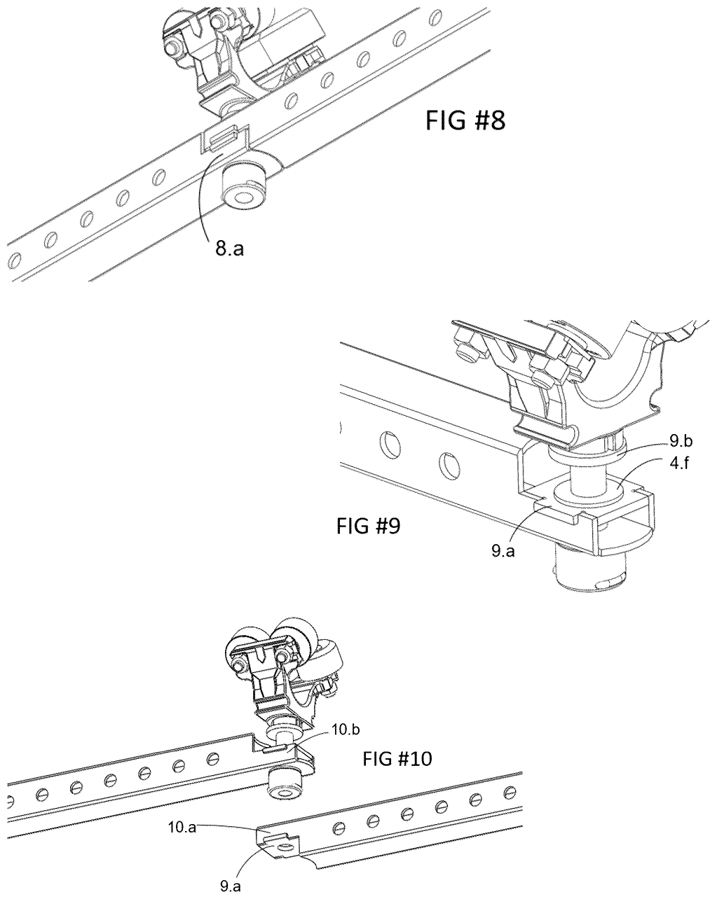

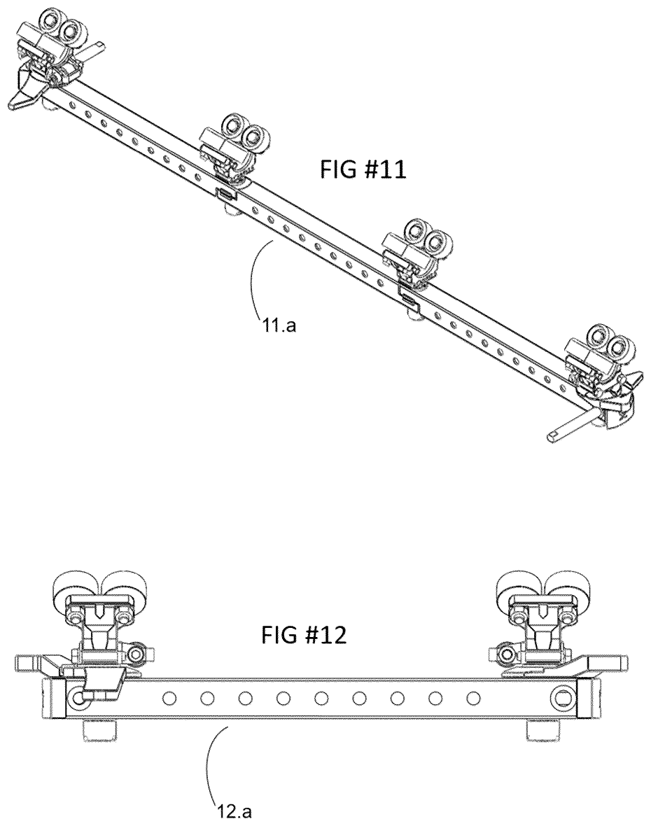

There are various alternatives for the buggies (11.a and 12.a), from at least one support (5.c), as shown in FIG. 12, to adding the required number of supports (5.c) through a sling (8.a), as shown in FIG. 8. This allows for the formation of a buggy (11.a and 12.a) of the appropriate dimension, whether two supports (5.c), three supports like the buggy (11.a) shown in FIG. 11, or more supports (5.c) as needed. These slings (8.a) consist of an assembly plate (9.a), which is welded to form a transverse cut on the support (5.c), a key feature of this new design that greatly increases the resistance of buggies (11.a) with two or more supports (5.c). The sling (8.a) includes an upper sling section (10.a) and a bottom sling section (10.b), separated by a spacer (9.b) and connected by the LOAD PIN (4.d) of the trolley (3.a), as clearly shown in FIGS. 9 and 10, respectively.

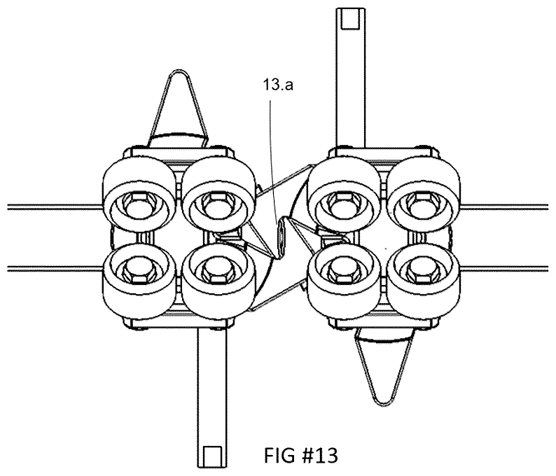

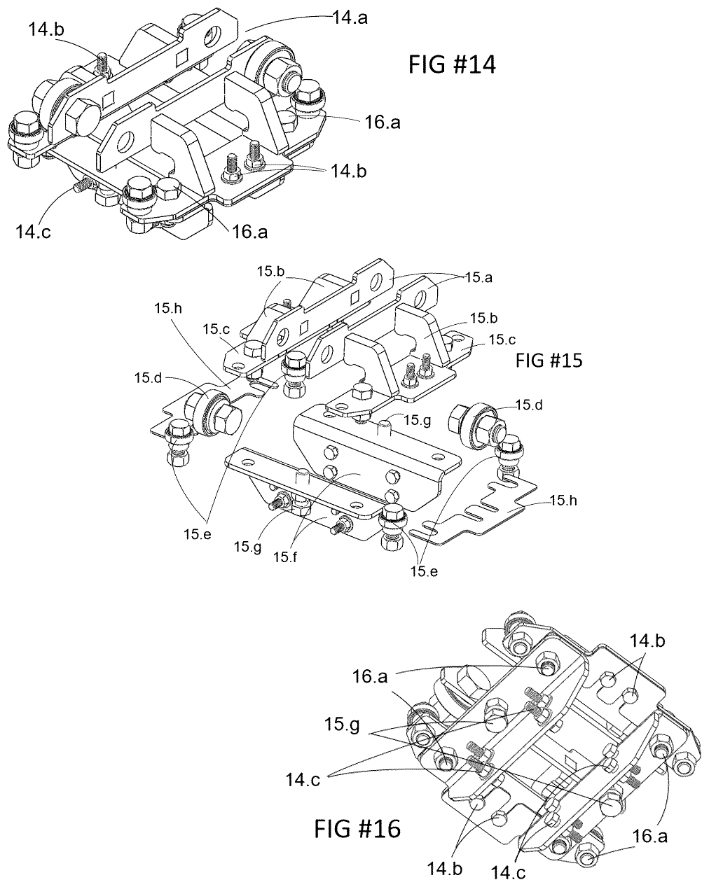

The mobile clamp (14.a), shown in FIGS. 14 and 16, is a key element, as it secures the flow rail (2.a) in the air to a structural element like a load beam (17.a), as shown in FIG. 17. This mobile clamp (14.a) consists of several elements also detailed in FIG. 15, including upper rail fastening screws (14.b), lateral rail fastening screws (14.c), four beam support units (15.b), which are the main inventive feature of the mobile clamp (14.a), allowing for the option of using or not using the bearing support assembly set (15.d). Even if this fails, the mobile clamp (14.a) will remain secured to the structural element like a load beam (17.a). It also includes at least two bearing beam fastening plates (15.a), at least two clamp assembly plate s (15.c), at least two bearing twist assembly set units (15.e), at least two lateral rail fastening plates (15.f), at least one permanent positioning screw (15.g), the possibility of having an height adjustment plate (15.h), and complete fastening screws (16.a). The bearing support assembly set (15.d) allows the flow rail (2.a) to move perpendicularly using ball bearings as rollers, while the bearing twist assembly set (15.e) keeps the flow rail (2.a) parallel to any adjacent flow rail (2.a), as shown in FIG. 17.

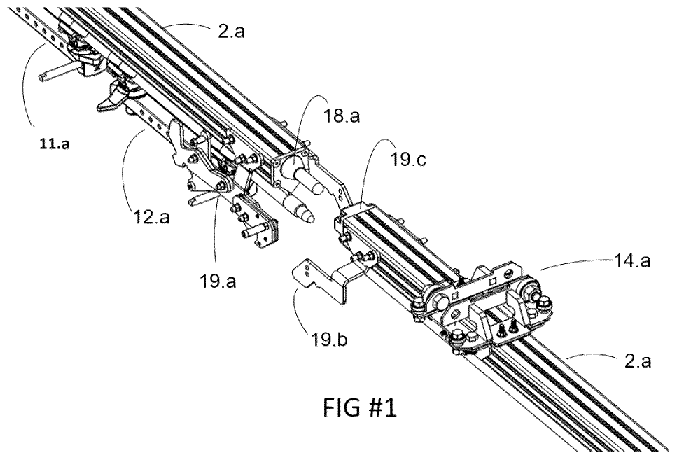

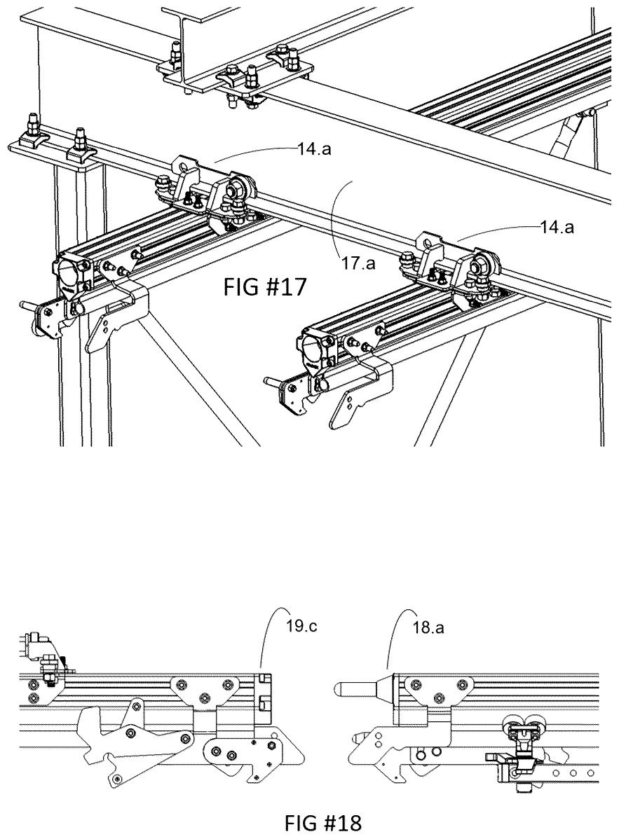

A fundamental part of the functionality of the system and/or device of the present invention is the connection of the flow rails (2.a) as it allows the movement of the Buggys (11.a and 12.a) from one flow rail (2.a) to another via the connector (18.a) and the receiver cone (19.c). When the flow rails (2.a) are disconnected, as shown in FIG. 18 and FIG. 1, these elements enable an almost perfect joint between the two flow rails (2.a) when they are connected.

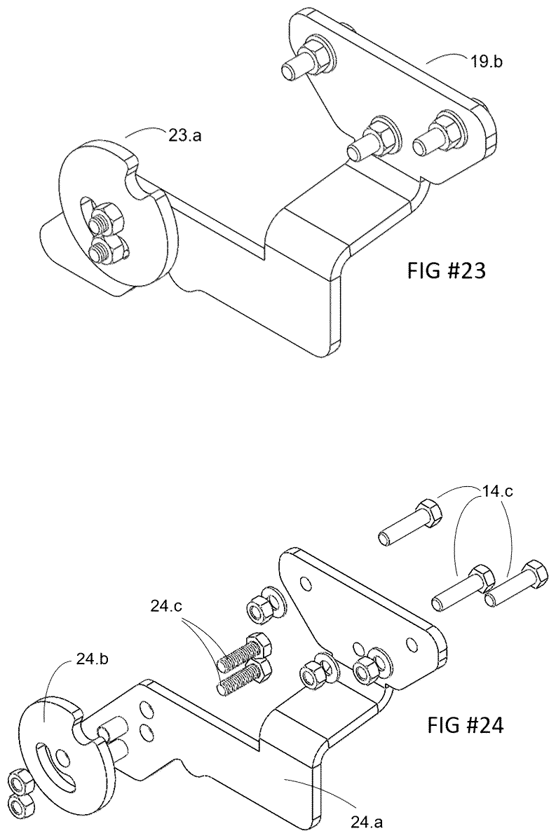

The elements that make up the connector (18.a), as shown in FIG. 26, include the connection bolt (26.a), which is the piece that enters the receiver cone (19.c), and with the help of the centering cone (26.b), a straighter alignment is achieved, allowing for a better connection and smoother passage of the Buggys (11.a and 12.a) through the lower travel bolt (26.d). The connector support (26.c) provides support and secures the connection between them and the flow rail (2.a) using the front rail fastening screw (26.e) and the centering cone fastening screw (26.f), as shown in FIG. 26. Meanwhile, the receiver cone (19.c) uses the cone fastening screw (25.a), as shown in FIG. 25.

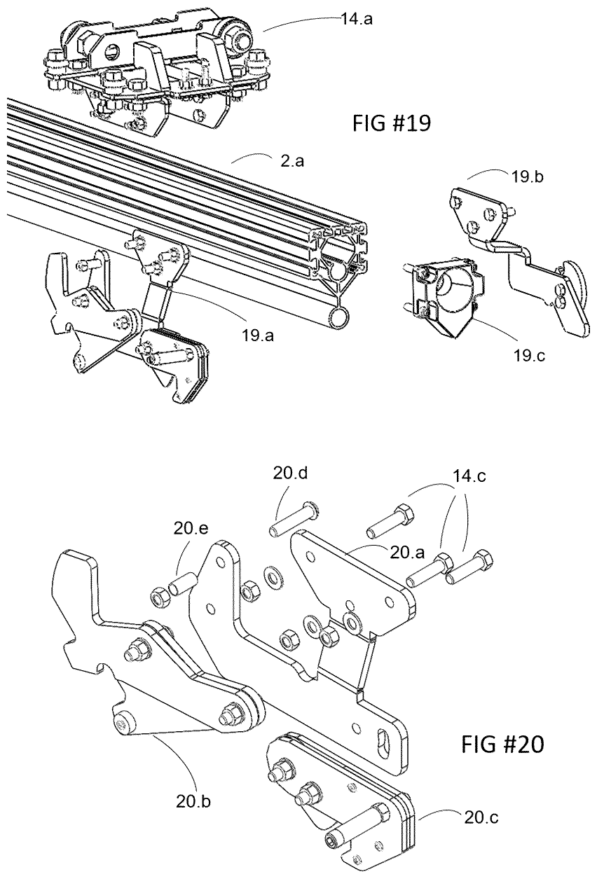

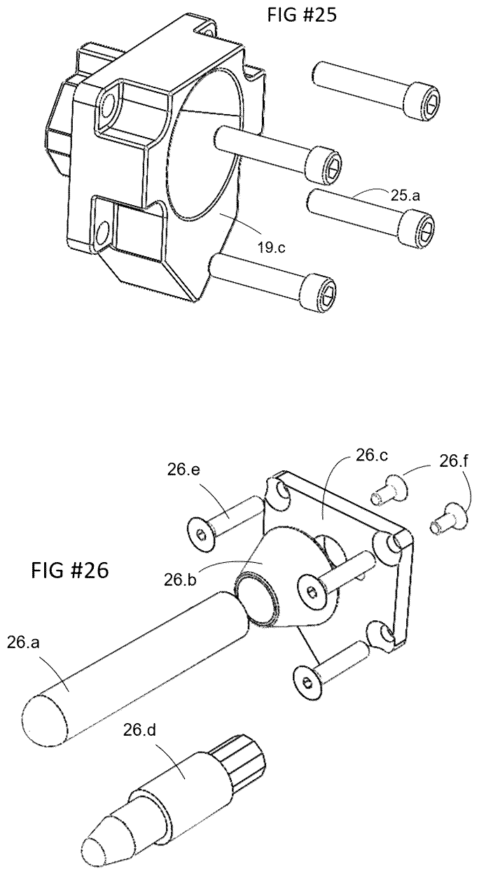

During the joining process, the gatekeeper (19.a) interacts with the releaser (19.b) to raise the lock (20.c) by rubbing it with the bolt elevation assembly for lock (22.d), causing the lock main support (22.a) to rise, as clearly shown in FIG. 27. The elements of the gate (19.a) include the gate support (20.a), which is the part fixed to the flow rail (2.a) with lateral rail fastening screws (14.c). This piece, which has an amorphous shape with at least two reverse folds, is also the element that holds the lock (20.c) and the doser (20.b). The doser interacts with the spacer for doser limiting screw (20.e), which is secured with a doser limiting screw (20.d), as shown in FIG. 20.

The doser (20.b), shown in FIG. 21, consists of the following elements: at least one activation rocker (21.b), an amorphous piece with several radii and at least two internal cavities, and possibly a counterweight (21.e) to allow its quick return to position by gravity. It also includes at least one advance limiter (21.a), both secured with at least one front fastening assembly for doser (21.c) and at least one rear fastening assembly for doser (21.d).

The lock (20.c), as shown in FIG. 22, features at least one lock main support (22.a), a piece that, through its cuts and shapes, gives the impression of a hook and is the element that stops the buggys (11.a and 12.a) when they make contact with the pin (5.d), which is also stopped by the anti-return element (22.b), if integrated. This element captures the pin (5.d), preventing the buggy (11.a and 12.a) from returning backward. The piece may also include the complement of the lock main support complement (22.c), connected by the bolt elevation assembly for lock (22.d) and front fastening assembly for lock (22.e). If necessary, it is reinforced by the lock union reinforcement screw (22.g). The rear fastening assembly for lock (22.f) acts as a pivot bolt to allow the swinging of the entire integrated element.

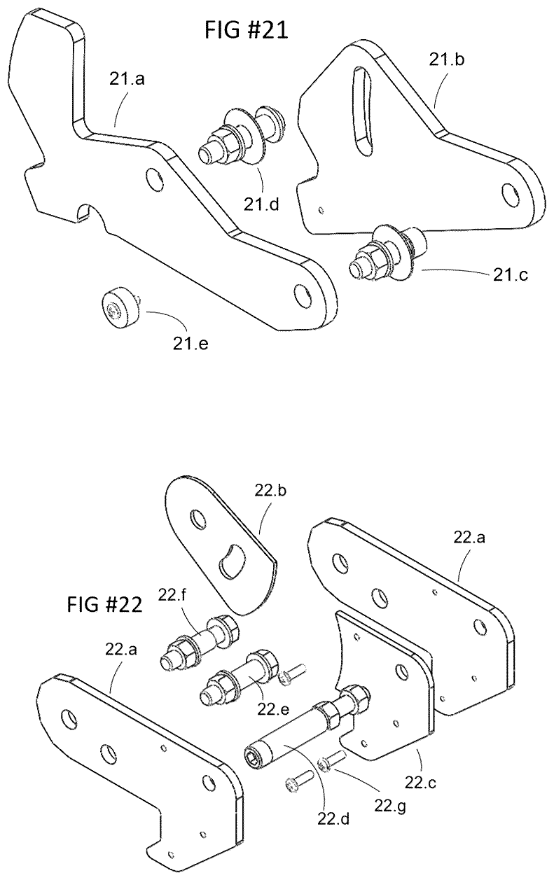

The releaser (19.b), shown in FIG. 24, consists of a releaser support (24.a), which, due to its amorphous shapes and angles, can be secured to the flow rail (2.a) with lateral rail fastening screws (14.c). It also serves as the base that supports the holder plate (24.b), which is secured with at least one holder fastening screw (24.c) and at least one holder spacer (24.d). These elements make up the holder (23.a), as shown in FIG. 23.

The holder (23.a) functions to create a locking point (27.a) by clamping the bolt elevation assembly for lock (22.d) so that once the flow rails (2.a) are connected, there is no accidental disconnection, preventing the buggys (11.a and 12.a) from falling while in between, i.e., neither on one rail nor the other, as shown in FIGS. 28, 29, and 30.

This innovative element is of great value for operators and companies as it helps prevent accidents.

In a first embodiment, the present invention provides an aerial accumulation and/or transport system of high durability and/or high load capacity and/or high resistance and/or high flexibility and/or high modularity for its application in industries that require the transport and/or accumulation of pieces, objects, products, materials, and others via an aerial rail and/or for material movements where the use of forklifts, carts, containers, and/or other methods of loading or moving items in contact with the floor are to be avoided. This invention enables the efficient aerial movement of items manually and/or using gravity and/or with external motorized support.

In a second embodiment, the present invention provides an aerial accumulation and/or transport device with high durability and/or high load capacity and/or high resistance and/or high flexibility and/or high modularity for its application in industries requiring transport and/or accumulation of pieces, objects, products, and materials, among others, via an aerial rail and/or for material movements that wish to avoid using forklifts, carts, containers, and/or other methods of loading or moving items in contact with the floor. This invention allows for the efficient aerial movement of pieces manually and/or by gravity and/or with external motorized support.

In a third embodiment, the present invention provides an aerial accumulation and/or transport device of high durability and/or high load capacity and/or high resistance and/or high flexibility and/or high modularity, aiming to facilitate, maximize, and improve the movement and accumulation of objects, products, and materials, among others.

The device of the present invention includes several mechanical elements and design features that enhance the functionality of the device. It primarily consists of a flow rail (2.a), shown in FIG. 2, which has as its main characteristic the presence of two fixing channels (2.b) on the sides and the top, all necessary for fixing functional elements, including the gate (19.a), receiver cone (19.c), connector (18.a), releaser (19.b), and a mobile clamp (14.a) as seen in FIG. 19. This is a significant difference compared to current systems, which only have a single guide on the side and one on top, limiting their functions and capabilities.

In the rolling tube (2.c) of the flow rail (2.a), the Buggys (11.a and 12.a) move, characterized by at least one trolley (3.a), composed of various elements, shown in FIG. 4, including the housing (4.a), the main body with several angles, cavities, and protrusions that are its distinctive features, such as a spring support (4.q) and guides for the 5th-wheel system supports (4.t). It also features a clamping plate (4.b), which has internal cuts and helps secure the rollers (4.c), the load pin (4.d), a rounded tubular piece with threads (4.r), and a fixing ring (4.s), which provides the connection to the flow rail. A spring (4.e) ensures the return of the link (5.a) when it interacts with the activation rocker (21.b) of the doser (20.b), a friction washer (4.f) to reduce wear, a nut (4.g) that secures the load, a cap (4.h) to protect the loaded items from abrasion, and a clip (4.i) that secures both the cap (4.h) and the nut (4.g) in place.

The trolley (3.a) now has the option of being equipped with a fifth-wheel system (3.b), shown in FIG. 3, which includes a support (4.j) that holds the 5th wheel (4.k) via a 5th-wheel pin (4.l) secured with a 5th-wheel nut (4.m). Everything is connected through the fifth-wheel clamp plate (4.n), which is secured with front clamping bolts (4.p) and pressure washers (4.o) to keep them in place. Having the option to use this system now gives the Buggys (11.a and 12.a) added functionality, preventing the trolley (3.a) from rubbing and thus slowing down when it experiences frontward twisting on a slope using gravity, motorization, or operator interaction.

For this movement and accumulation process, at least one Buggy (11.a and 12.a) is used, selected based on the size and/or weight of the object, product, or material, to ensure it is preferably within the shock absorber (5.g) for protection during movement and/or accumulation. The ends of the Buggys (11.a and 12.a), as shown in FIG. 5, include several elements for their functionality, such as the link (5.a) which allows for the connection with another Buggy (11.a and 12.a) through a linkage (13.a), as shown in FIG. 13, a link protector (5.b) to prevent wear, a support (5.c) where the load will be added by securing it through the load drillings (7.b), a pin (5.d) that, with the help of a pin washer (5.e) and a pin pressure washer (5.f), is secured to the support (5.c) through a rivet (7.a), as shown in FIG. 7, providing much greater resistance and allowing for the potential replacement of the pin (5.d) after stoping engages shocks from the lock (20.c), preventing the Buggy (11.a and 12.a) from being restricted. This is very important because the pin (5.d) will also generate interaction with the advance limiter (21.a), as shown in FIG. 30, and will eventually cause the breaking of the linkage (13.a), as shown in FIG. 31, through a left-to-right movement cadence seen from that perspective.

It is important to mention that now the link (5.a), as shown in FIG. 6, features a key differentiator: link core (6.a) that increases the piece's resistance by being inside the cover of the link (6.b).

There are different alternatives for Buggys (11.a and 12.a), which can include at least one support (5.c), as shown in FIG. 12, or by adding the necessary number of supports (5.c) through a sling (8.a), as shown in FIG. 8, so that a Buggy (11.a and 12.a) of the appropriate size can be formed. This can be two supports (5.c), three supports as in Buggy (11.a), shown in FIG. 11, or more supports (5.c) as required. These slings (8.a) are formed by a assembly plate (9.a) that shapes a cross-section around the support (5.c), which is a key feature of this new design that greatly increases the resistance of Buggys (11.a) with two or more supports (5.c). The sling (8.a) consists of an upper sling section (10.a) and a bottom sling section (10.b) separated by a spacer (9.b), and connected by the LOAD PIN (4.d) of the Trolley (3.a), as clearly shown in FIGS. 9 and 10, respectively.

The mobile clamp (14.a), shown in FIGS. 14 and 16, is a key element as it allows the aerial attachment of the flow rail (2.a) to a structural element like a load beam (17.a), as shown in FIG. 17. This mobile clamp (14.a) consists of several elements also detailed in FIG. 15, which include upper rail fastening screws (14.b), lateral rail fastening screws (14.c), four beam support units (15.b)—a main feature of the design, enabling the use or non-use of the bearing support assembly set (15.d). Even if the mobile clamp (14.a) breaks, it will remain supported by the structural element such as the load beam (17.a). It also has at least two bearing beam fastening plates (15.a), at least two clamp assembly plate (15.c), at least two bearing twist assembly set units (15.e), at least two lateral rail fastening plates (15.f), at least one permanent positioning screw (15.g), the possibility of a height adjustment plate (15.h), and complete fastening screws (16.a). The bearing support assembly set (15.d) allows the flow rail (2.a) to move side to side perpendicularly by using bearings as rollers, while the bearing twist assembly set (15.e) keeps the flow rail (2.a) in parallel to an adjacent flow rail (2.a), as shown in FIG. 17.

A fundamental part of the device's functionality is the connection of the flow rails (2.a), as it allows the movement of Buggys (11.a and 12.a) from one flow rail (2.a) to another via the connector (18.a) and the receiver cone (19.c). When the flow rails (2.a) are disconnected, as seen in FIG. 18 and FIG. 1, these elements make it possible to create an almost perfect joint between both flow rails (2.a) when they are connected.

The elements forming the connector (18.a), as shown in FIG. 26, are the connection bolt (26.a), which is the part that enters the receiver cone (19.c), and through the centering cone (26.b), a straighter alignment is achieved, enabling a better connection and flow of the Buggys (11.a and 12.a) through the lower travel bolt (26.d). The connector support (26.c) provides support and fastening between the connector and the flow rail (2.a), using the front rail fastening screw (26.e) and the centering cone fastening screw (26.f), as shown in FIG. 26. The receiver cone (19.c) uses a cone fastening screw (25.a), as shown in FIG. 25.

During the joining process, the gate (19.a) interacts with the releaser (19.b) to lift the lock (20.c) by the friction of the latter with the bolt elevation assembly for lock (22.d), which raises the lock main support (22.a), as clearly shown in FIG. 27. The gate (19.a) elements include the gate support (20.a), which is the piece that attaches to the flow rail (2.a) using lateral rail fastening screws (14.c). This piece, with an amorphous shape and at least two reverse folds, is also the element that holds the lock (20.c) and the doser (20.b), the latter interacting with the spacer for doser limiting screw (20.e), which is held by a doser limiting screw (20.d), as seen in FIG. 20.

The doser (20.b), shown in FIG. 21, contains the following elements: at least one activation rocker (21.b), an amorphous piece with several radii and at least two internal cavities, which may have a counterweight (21.e) to allow rapid return to position by gravity, and at least one advance limiter (21.a). Both are held by at least one front fastening assembly for doser (21.c) and at least one rear fastening assembly for doser (21.d).

The lock (20.c), shown in FIG. 22, features at least one lock main support (22.a), which through its cuts and shapes resembles a hook and is the element that stops the buggys (11.a and 12.a) when it contacts the pin (5.d), which is also stopped by the anti-return element (22.b), if integrated, as it traps the pin (5.d), preventing the buggy (11.a and 12.a) from moving backward. The piece may contain a lock main support complement (22.c) connected by the bolt elevation assembly for lock (22.d) and the front fastening assembly for lock (22.e). If necessary, a lock union reinforcement screw (22.g) can be used. The rear fastening assembly for lock (22.f) functions as a pin axle to allow the swinging of the entire integrated element.

The releaser (19.b), shown in FIG. 24, consists of a releaser support (24.a), which, due to its amorphous shape and angles, can be attached to the flow rail (2.a) using lateral rail fastening screws (14.c). It is also the base that holds the holder plate (24.b) via at least one holder fastening screw (24.c) with at least one holder spacer (24.d), forming the holder (23.a), as shown in FIG. 23.

The holder (23.a) is an option designed to generate a locking point (27.a) by clamping the bolt elevation assembly for lock (22.d) so that once the flow rails (2.a) are connected, there is no accidental disconnection, and the buggys (11.a and 12.a) cannot fall when they are in between, i.e., not on one rail or the other, as shown in FIGS. 28, 29, and 30. This innovative element is of great value for operators and companies, preventing accidents.

In a fourth variation of the present invention, the system and/or device includes at least one flow rail with at least two fixation channels on at least one of its sides, through which at least one trolley moves and/or is stored; the flow rail features at least one round-shaped roller tube on its exterior, supported by a vertical plate, which allows the sliding of the rollers. The trolley, with defined shapes, lines, and angles, has at least one cavity or support that allows it to integrate additional elements such as rollers and/or springs or dampers, such as the ability to have a 5th wheel. The trolley has a load pin that is an elongated rounded tube with at least one threaded element and at least one fixing ring. The trolley also includes at least one clip to secure its lid and hold its nut. Once the Buggy is assembled, it may include at least one link with an integrated core made of another material that increases its resistance. The buggy, for its part, includes supports with at least one rivet acting as a pin fixing element. When using Buggys with two or more supports, they include at least one sling made by cutting one of the main support ends, to which a structural plate is welded, enhancing its resistance at the joint without adding extra elements except for a spacer and a friction washer. The flow rail device can also include at least one gate and/or receiving cone and/or connector and/or releaser and/or mobile clamp. The gate can integrate a doser with at least two pieces, potentially with a counterweight, and may also include at least one lock that can integrate an anti-return element and can be made of at least three parts. The use of mobile clamps allows the flow rail to be attached to a structural element. These mobile clamps may include at least one element allowing the optional use of a bearing support. When a connection between two flow rails is needed, at least one connector is used, which integrates at least one centering cone for a better connection, and this connection is secured by the gate interacting with the releaser when the receiving cone and the connector are joined; the releaser may include at least one integrated fastener.

The procedure for manufacturing the system and/or device of the present invention is widely known to those skilled in the art, so it will not be discussed in detail. In fact, for the purposes of this utility model, various materials and dimensions currently available on the market may be considered for use.

What is claimed is:

1. A suspended transport system comprising:
at least one flow rail having:
a main body having at least two fixation channels on at least one side thereof operable to engage one or more components to be affixed thereto, and at least one roller tube coupled thereto with a vertical plate;
at least one buggy operable to travel along the flow rail, said buggy comprising:
a trolley having one or more rolling elements operable to engage the roller tube and travel therealong; and
at least one linking device with an integrated core of another material that increases its strength.

2. The system of claim 1, wherein the trolley has at least one cavity or support that allows it to integrate additional elements and, if necessary, to include a 5th wheel.

3. The system of claim 1, wherein the buggy device is formed with at least one support, where the support device is an element that holds the load to be transported and is used when the capacity of the trolley needs to be increased.

4. The system of claim 3, wherein the support device includes at least one rivet that acts as a fastening element.

5. The system of claim 1, wherein the linking device connects a plurality of buggies, allowing one to pull the others, moving together one after the other.

6. The system of claim 1, wherein the buggy further includes a shock-absorbing device operable to absorbe the impact between buggies when they contact one another.

7. The system of claim 1, wherein the flow rail device further includes at least one port device, at least one receiver cone, at least one connector, at least one releaser, and at least one mobile clamp.

8. The system of claim 7, wherein the port device includes an integrated dispensing device with at least two pieces, and at least one counterweight.

9. The system of claim 7, further comprising at least one locking device, which can integrate an anti-return device and is installed at a specific point on the rail to stop the buggy at a specific location, and the anti-return mechanism prevents the buggy from moving out of position.

10. The sytem of claim 9, wherein the dispensing device is operable to break the link to release one buggy at a time, and the releaser works with the locking device to lift and allow free passage of buggies.

11. The system of claim 7, wherein the mobile clamp device enables the flow rail to be secured to a structural element.

12. The system of claim 4, wherein the fastener element is operable to connect a plurality of rails.
